(19) United States
(12) Patent Application Publication
(10) Pub. No.: US 2006/0105617 A1
(43) Pub. Date: May 18, 2006

(54) Connector latches

(75) Inventors: Kenny Padro, Hamden, CT (US); James M. Giroux, Thomaston, CT (US)

Correspondence Address: ROTHWELL, FIGG, ERNST & MANBECK, P.C., 1425 K STREET, N.W., SUITE 800, WASHINGTON, DC, 20005, US

(73) Assignee: Litton Systems, Inc., Los Angeles, CA (US)

(21) Appl. No.: 10/988,705

(22) Filed: Nov. 16, 2004

(51) Int. Cl. H01R 13/00

(52) U.S. Cl. 439/484

(57) ABSTRACT

A connector latch according to the present invention is described. The connector latch comprises a generally U-shaped member having laterally extending arms, a body portion, and a spring member integral with the arms. The connector latch also includes cantilever beams projecting outwardly from the spring member. The cantilever beams deflect proportional to an applied force or load. The spring member biases against the force generated by the cantilever beams, and the arms and body portion bias against compression of the spring member. In another embodiment, a latching system is provided. The latching system includes an end cap comprising a first generally U-shaped member having a body portion. The body portion includes a first arm member, a second arm member, and a connector member having at least one of a first connector surface and a second connector surface. A connector latch is affixed to the at least one of the first and second connector surfaces. The connector latch comprises a second generally U-shaped member having outer spring loops including first end and upper surfaces, inner spring loops including second end and upper surfaces, and a spring member formed at the second upper surfaces of the inner spring loops. The latching system biases against compression produced from a compression mount type connector system.

### BACKGROUND OF THE INVENTION

The present invention relates generally to a connector latch and, in particular, to a mechanical connector latch used in connection with electrical interconnection systems, such as, e.g., the SIP1000 I-Platform™ Interconnection System, which is disclosed in International Application No. PCT/US03/22896, filed Jul. 23, 2003, and incorporated herein in its entirety by reference.

Electrical connectors that electrically connect circuit boards such as backpanels to daughtercards suffer from various deficiencies including, e.g., the inability to connect and disconnect many times without damaging the electrical connector. Such deficiencies limit the reliability of the data rate that can be transferred through the connector. Thus, a need exists in the art for a connector latch that allows the removal and insertion of an electrical connector without damaging it, in addition to the removal and insertion of a circuit board with ease.

### SUMMARY OF THE INVENTION

In some embodiments of the present invention, a connector latch is disclosed. The connector latch can include a generally U-shaped member having laterally extending arms, a body portion, and a spring member integral with the arms. The connector latch also includes cantilever beams projecting outwardly from the spring member. The cantilever beams deflect proportional to an applied force or load. The spring member biases against the force generated by the cantilever beams, and the arms and body portion bias against compression of the spring member.

In other embodiments of the present invention, a combination of an interconnection system and a connector latch is disclosed. The combination can include an interconnection system having a pair of end pieces arranged to be disposed at adjacent ends of a plurality of spacers, and a connector latch affixed to at least one of the end pieces. The connector latch comprises a generally U-shaped member having laterally extending arms, a body portion, and a spring member integral with the arms. The connector latch also includes cantilever beams projecting outwardly from the spring member. The cantilever beams deflect proportional to an applied force or load. The spring member biases against the force generated by the cantilever beams, and the arms and body portion bias against compression of the spring member.

In yet other embodiments of the present invention, a combination of an interconnection system and a connector latch is disclosed. The combination comprises an interconnection system having a plurality of spacers, and a connector latch arranged to be disposed at adjacent ends of the plurality of spacers. The connector latch comprises a generally U-shaped member having laterally extending arms, a body portion, and a spring member integral with the arms. The connector latch also includes cantilever beams projecting outwardly from the spring member. The cantilever beams deflect proportional to an applied force or load. The spring member biases against the force generated by the cantilever beams, and the arms and body portion bias against compression of the spring member.

In further embodiments of the present invention, a latching system is disclosed. The latching system includes an end cap comprising a first generally U-shaped member having a body portion. The body portion includes a first arm member, a second arm member, and a connector member having at least one of a first connector surface and a second connector surface. A connector latch is affixed to the at least one of the first and second connector surfaces. The connector latch comprises a second generally U-shaped member having outer spring loops including first end and upper surfaces, inner spring loops including second end and upper surfaces, and a spring member formed at the second upper surfaces of the inner spring loops. The latching system biases against compression produced from a compression mount type connector system.

The above and/or other features, aspects and/or advantages of the present invention, as well as the structure and operation of various embodiments of the present invention, will be further appreciated based on the following description in conjunction with the attached drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention according to some preferred embodiments and to enable a person skilled in the pertinent art to make and use the invention. In the drawings, like reference numbers indicate identical or functionally similar elements. A more complete appreciation of the preferred embodiments and many of the attendant advantages thereof will be readily obtained as the same becomes better understood by reference to the following detailed description in connection with the accompanying drawings, wherein:

FIG. 1 illustrates a side view of the connector latch according to an exemplary embodiment of the present invention;

FIG. 2 illustrates an isometric view of the connector latch according to an exemplary embodiment of the present invention;

FIG. 3 illustrates an end view of the connector latch according to an exemplary embodiment of the present invention;

FIG. 4 shows a non-mating state of the connector latch according to the present invention with a mating latch of a backpanel;

FIG. 5 shows the connector latch according to the present invention mating with a mating latch of the backpanel;

FIG. 6 illustrates a side view of the connector latch according to a second embodiment of the present invention;

FIG. 7 shows components of a latching system comprising the connector latch of FIG. 6 and an end cap of an electrical connector; and

FIG. 8 shows a consolidated latching system comprising the connector latch of FIG. 6 and an end cap of an electrical connector.

### DETAILED DESCRIPTION OF THE EXEMPLARY EMBODIMENTS

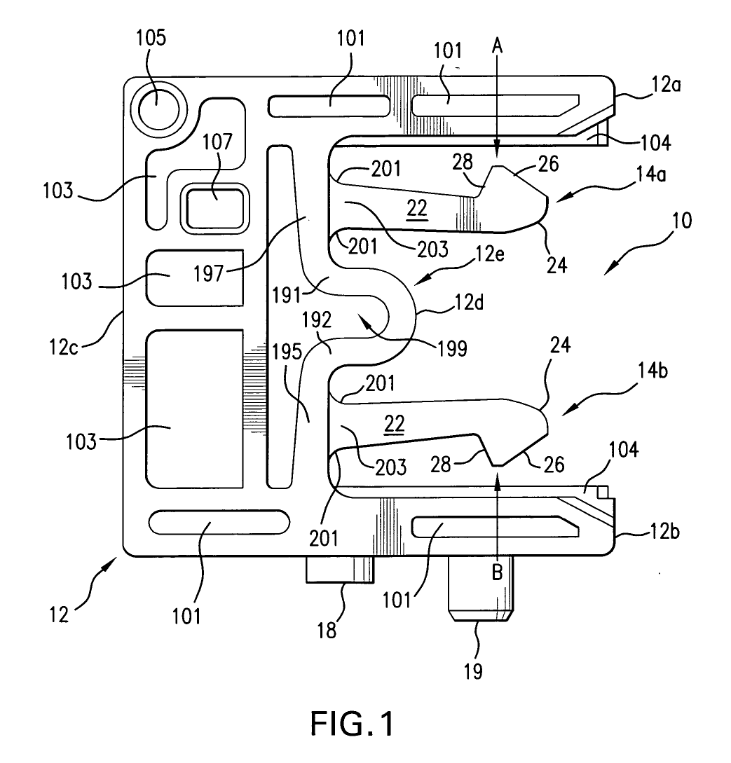

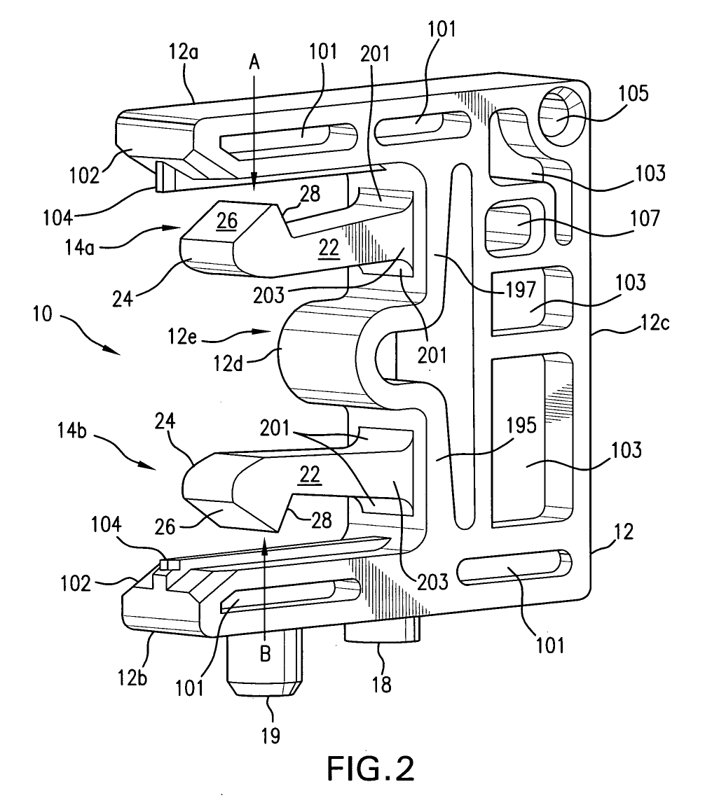

FIG. 1 illustrates a side view of a connector latch 10, and FIG. 2 illustrates an isometric view of the connector latch 10 according to an exemplary embodiment of the present invention. Referring to FIGS. 1 and 2, the connector latch 10 comprises a generally U-shaped member 12 having laterally extending arms 12a, 12b, a body portion 12c and a spring portion 12e.

Spring portion 12e has a generally u-shaped portion 12d, a first arm 197 and a second arm 195. The generally u-shaped portion 12d has a first upper portion 191 and a second upper portion 192. The generally u-shaped portion 12d is located between first arm 197 and second arm 195. The ends of arms 197, 195 are connected to arms 12a, 12b, respectively. In some embodiments, the ends of arms 197, 195 are integral with arms 12a and 12b, respectively. As shown in FIG. 1, arms 12a and 12b, body portion 12c, and spring portion 12e define a generally T shaped hole 199.

The connector latch 10 also includes cantilever beams 14a, 14b connected to arms 197, 195, respectively, and projecting outwardly in the same direction as arms 12a, 12b. Like beams 14a, 14b, the generally u-shaped portion 12d, extends outwardly in the same direction as arms 12a, 12b, and is located between beams 14a, 14b.

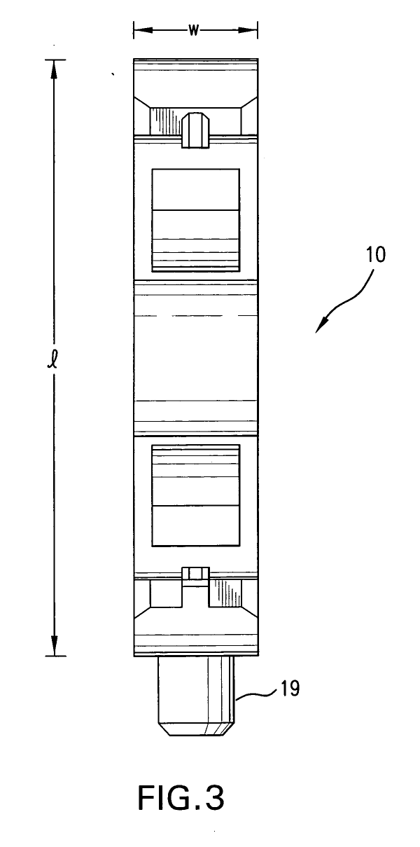

The connector latch 10 is preferably made of molded plastic. The connector latch 10 is approximately 1.0 inch in height and approximately 1.0 inch in width, with a thickness of approximately 0.200 inches (FIG. 3).

The connector latch 10 can be placed at each end of an electrical connector. For example, the connector latch 10 can be placed on the end caps of an electrical connector. The configuration of the connector latch 10 accommodates stacking of circuit boards, thereby reducing the size and the number of components of the interconnection system, and provides alignment guidance of the circuit boards.

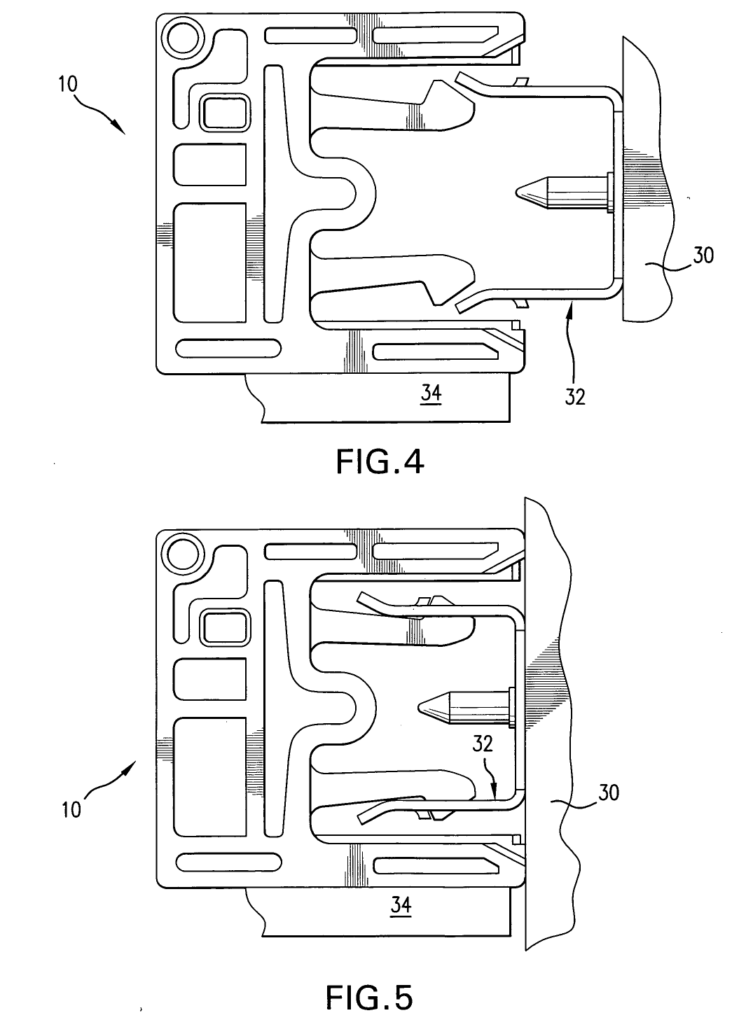

As illustrated in FIG. 2, the arms 12a, 12b can include elongated holes 101. The holes 101 provide a consistent, uniform wall thickness. The arms 12a, 12b have a sloped front surface 102 that projects outwardly from the cantilever beams 14a, 14b, and a protrusion 104 that extends along the length of the arm 12a, 12b. At least one arm 12a, 12b can include a peg 18 and a molded screw 19 on its outer surface. The peg 18 can be located near the center of the arm 12a, 12b, and act like a PEM™ screw that can be molded in the end cap. The outer surface of the arm 12a, 12b containing the molded screw 19 can be mounted to a daughtercard 34 (FIGS. 4 and 5).

The body portion 12c can include recesses 103 having different geometry, and apertures 105, 107. Similar to the holes 101, the recesses 103 provide a consistent, uniform wall thickness. The apertures 105, 107 are mounting holes that facilitate mounting of the end caps of the electrical connector to the connector latch 10. The orientation features of the apertures 105, 107 ensure that the connector latch 10 is square with the electrical connector.

The cantilever beams 14a, 14b have curved radii 201, a tapered intermediate/interim body 22, a base portion 203, and a top portion 24. The top portion 24 has a slanted face 26 and a sloped portion 28. The width of the intermediate body 22 decreases from the base portion 203 to the top end on the side facing the sloped portion 28 of the top portion 24. The top portions 24 of the cantilever beams 14 face away from each other; each slanted face 26 faces the interior surface of the respective arm 12. As shown in FIG. 2, the base portion 203 of beams 14a, 14b, may be connected to the bottom surface of arms 197, 195, respectively.

The cantilever beams 14a, 14b deflect proportional to the force or load applied to the connector latch 10 in directions A, B, respectively. The spring 12e biases against the force generated by the cantilever beams 14a, 14b, and the connector latch 10 biases against the compression of the spring 12e at the apertures 105, 107 and the peg 18. For example, a load boundary condition of 25 lbs per beam produces a displacement in the V and −V directions of 0.043 inches. At the top portion 24, the displacement is 0.060 inches for each cantilever beam 14 and the same load boundary condition.

FIG. 4 shows a non-mating state of the connector latch 10 of the present invention with a mating latch 32 of a circuit board (e.g., a backpanel) 30, and FIG. 5 shows the connector latch 10 mating with a mating latch 32 (mating state). Referring to FIGS. 4 and 5, the circuit board 30 has a mating latch 32. The connector latch 10 mates with the mating latch 32 of the circuit board 30 using card latching. There are two angles associated with the latching. The angle near the slanted face 26 is the insertion angle. This angle is approximately 30 degrees. It controls the amount of force required to mate the connector latch 10, which is mounted to a second circuit board (e.g., a daughtercard) 34, to the backpanel 30. The second angle, e.g., near the sloped portion 28, allows the connector latch 10 to remain attached to the backpanel 30. The angle is approximately 20 or 70 degrees (depending on how the angle is measured). A large force unmates the connector latch 10 that exists from the total force from compression springs pushing on the backpanel 30. Accordingly, no physical contact is required for the insertion or removal of the connector latch 10.

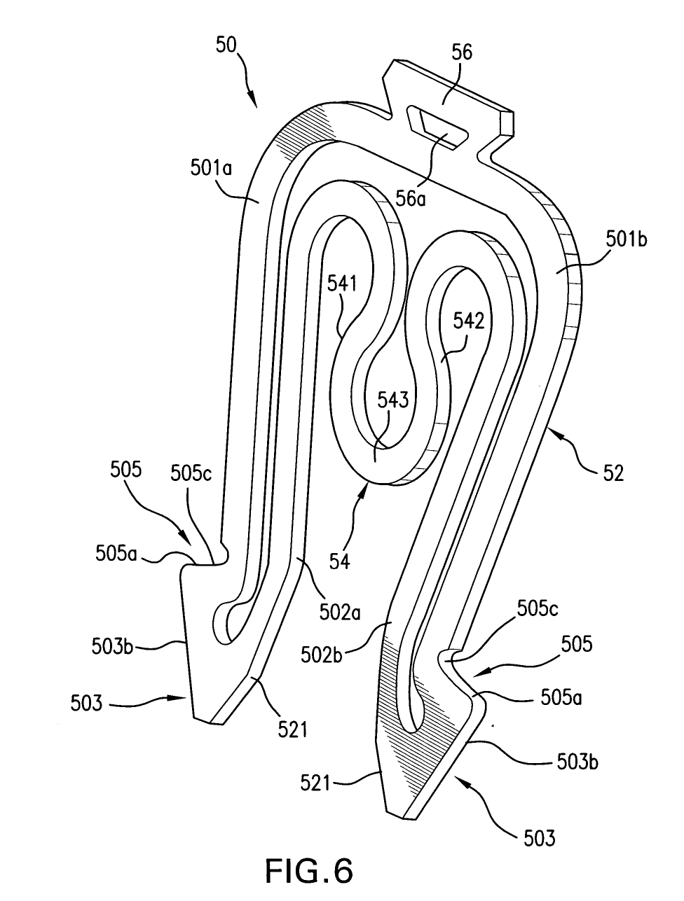

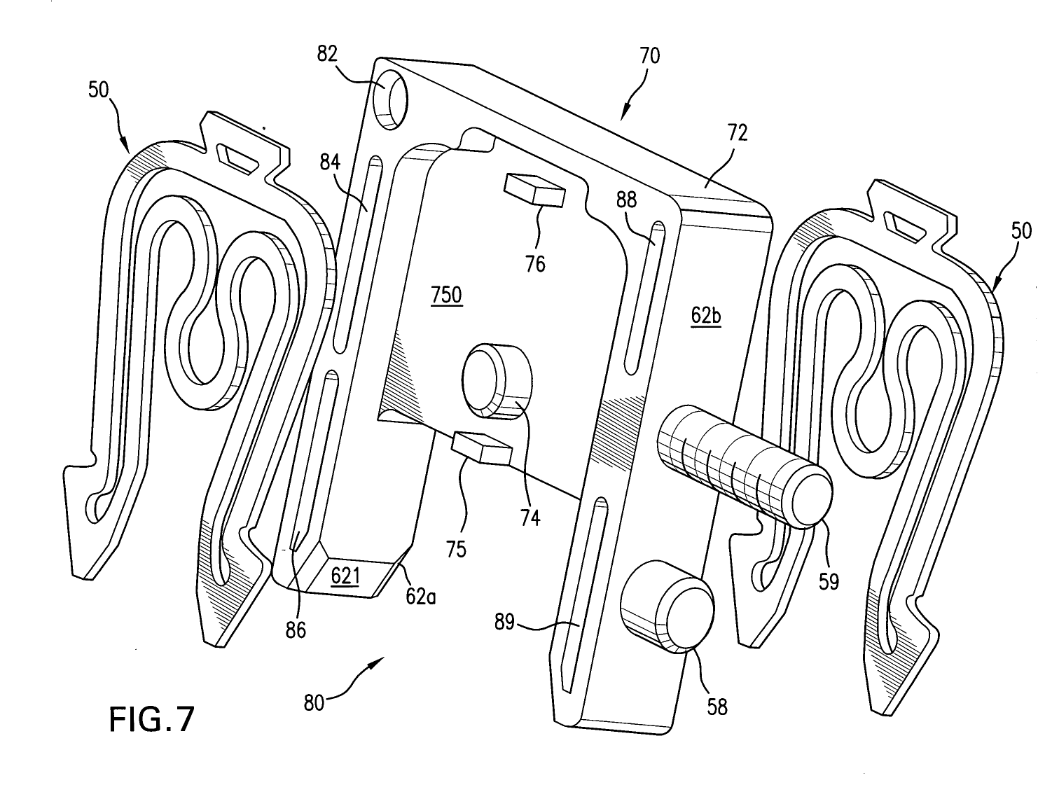

FIG. 6 illustrates a side view of a connector latch 50 according to a second embodiment of the present invention. Referring to FIG. 6, the connector latch 50 comprises a generally U-shaped member 52 having outer spring loops 501a, 501b and inner spring loops 502a, 502b.

The end surfaces of the outer spring loops 501a, 501b include a sloped portion 505 having unmating angles 505a, 505c, and a slanted portion 503 having mating angles 503b. The two unmating angles 505a, 505c formed on the sloped portion 505 give the connector latch 50 the force load adjustability needed to control the operational range of the backpanel 30 (FIGS. 4 and 5).

The end surfaces of the inner spring loops 502a, 502b include a curved portion 521. The end surfaces of the outer spring loops 501a, 501b and the end surfaces of the inner spring loops 502a, 502b are joined together and form a continuous member.

A latch mounting member 56 having an aperture 56a for mounting to an end cap 70, as discussed in greater detail below, is formed on the upper, outer surface of the outer spring loops 501a, 501b. As illustrated in FIG. 6, the aperture 56a has a quadrilateral (e.g., 4-sided) configuration. It will be appreciated by those skilled in the art that the aperture 56a may have other configurations, such as, triangular, circular, trapezoidal, etc.

The upper surfaces of the inner spring loops 502a, 502b are joined together and form a spring member 54. The spring member 54 has a generally u-shaped portion 54a for mounting to the end cap 70, as discussed in detail below. The generally u-shaped portion 54a has a first portion 541, a second portion 542, and a center portion 543. As discussed above, the generally u-shaped portion 54a is located between the upper surfaces of the inner spring loops 502a, 502b. In some embodiments, the upper surfaces of the inner spring loops 502a, 502b are integral with the first portion 541 and the second portion 542 of the spring member 54, respectively.

The connector latch 50 has a thickness of approximately 0.025 inches. The connector latch 50 is preferably stamped from a copper alloy metal. It will be appreciated by those skilled in the art that the connector latch 50 can be formed using other material, such as plastic or other metal alloys.

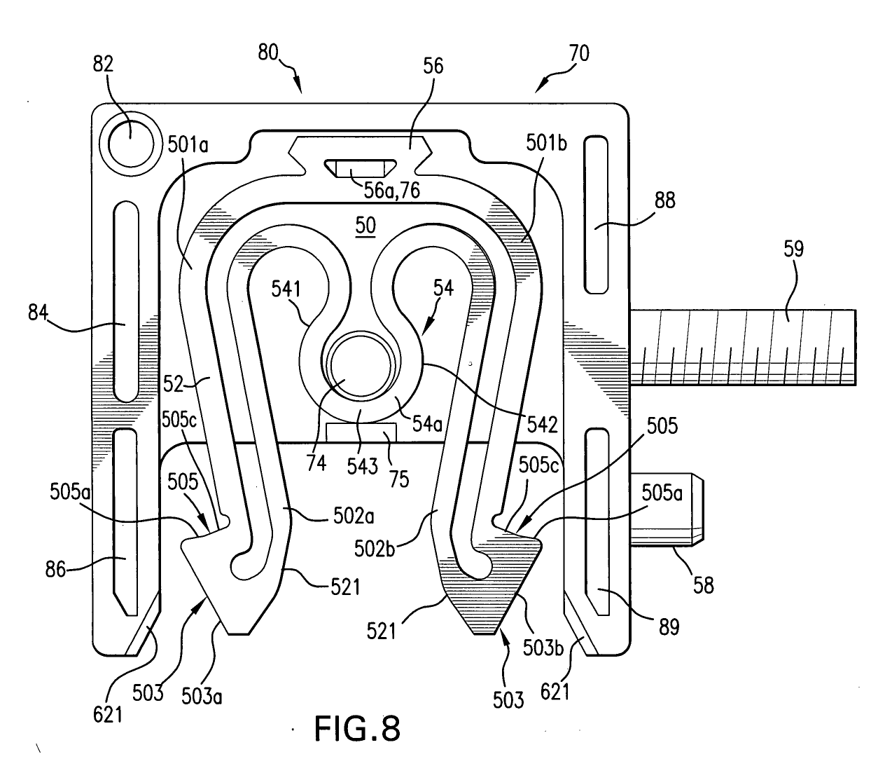

FIG. 7 shows the connector latch 50 and the end cap 70 in their non-mating state, and FIG. 8 shows the connector latch 50 mated to the end cap 70. As shown in FIG. 7, the end cap 70 comprises a generally U-shaped configuration having a body portion 72 including arm portions 62a, 62b, and a connector member 750 having an inner and/or outer connector surface. The connector member 750 can be integrally connected to the inner surfaces of the arm portions 62a, 62b. The end cap 70 is approximately 1.0 inch in height and approximately 1.0 inch in width, with a thickness of approximately 0.240 inches.

The connector latch 50 is securely retained on or mated to the connector member (connector surface) 750 of the end cap 70. For example, the connector member 750 includes a protrusion 76 for insertion into the aperture 56a of the connecter latch 50. The protrusion 76 has the same configuration as the aperture 56a of the connector latch 50. The connector member 750 further includes an oval/circular spring peg 74 and a spring protrusion 75 for securing the center portion 543 of the spring member 54 (of the connector latch 50) to the end cap 70. For simplicity, only the outer surface of the connector member 750 is shown in FIG. 7. However, the above description is applicable to the inner surface of the connector member 750.

At least one arm portion 62a, 62b can include a peg 58 and a molded screw 59 on its outer surface. Preferably, the peg 58 can be located near the lower end of the arm portion 62a, 62b, and the molded screw 59 can be located near the center of the arm portion 62a, 62b. In other embodiments, the peg 58 can be located near the center of the arm portion 62a, 62b, and the molded screw 59 can be located near the lower end of the arm portion 62a, 62b. The outer surface of the arm portion 62a, 62b containing the molded screw 59 can be mounted to the daughtercard 34 (FIGS. 4 and 5).

The arm portions 62a, 62b have a sloped front surface 621. In addition, the arm portions 62a, 62b can include apertures 82-89 having different geometry and providing a consistent, uniform wall thickness. The orientation features of the apertures 82-89 ensure that the connector latch 50 is square with the electrical connector.

Due to the relatively small size of the connector latch 50, at least two connector latches can be stacked side by side and on both sides of the connector member 750 (of the end cap 70), such that a large range of latching force is provided to counter the force produced from a compression mount type connector system. Similarly, the configuration of the connector latch 50 accommodates stacking of circuit boards, thereby reducing the size and the number of components of the interconnection system, and provides alignment guidance of the circuit boards.

Referring to FIG. 8, when the connector latch 50 is mated to the end cap 70, a latching system 80 is formed. The latching system 80 can be attached to both ends of a connector system (e.g., used for latching duties), and to the backpanel 30 or motherboard of an electrical system (e.g., used for carrying data or other types of electrical signals or power). In some embodiments, the connector latch 50 is not used as an electrical path; however, it can be if needed.

The connector latch 50 can accommodate relatively large beam deflections with force loads of approximately 10 lbs per connector latch. Further, since the connector latch 50 is made of a metal alloy, the latching system 80 is not sensitive to large thermal loads.

The connector latches of the present invention solve the deficiencies of electrical connectors by allowing the removal and insertion of the electrical connectors without damaging them. Further, the connector latches of the present invention provide the removal and insertion of circuit boards with ease.

While a preferred embodiment of the present invention has been described above, it should be understood that it has been presented by way of example only, and not limitation. Thus, the breadth and scope of the present invention should not be limited by the above described exemplary embodiment.

What is claimed:

1. A connector latch comprising:
a generally U-shaped member having laterally extending arms, a body portion, and a spring member integral with said arms; and
cantilever beams projecting outwardly from said spring member, said cantilever beams being deflected proportional to an applied force or load,
wherein said spring member biases against the force generated by said cantilever beams, and said arms and body portion bias against compression of said spring member.

2. The connector latch of claim 1, wherein at least one of said arms includes a screw on its outer surface for mounting to a circuit board.

3. The connector latch of claim 1, wherein at least one of said arms includes a peg on its outer surface to mold in an end cap of an electrical connector.

4. The connector latch of claim 1, wherein said arms include a plurality of elongated holes.

5. The connector latch of claim 1, wherein said arms include a sloped front surface that projects outwardly from said cantilever beams, and a protrusion that extends along the length of said arms.

6. The connector latch of claim 1, wherein said body portion includes a plurality of recesses and apertures.

7. The connector latch of claim 1, wherein said spring member includes an upper portion and a lower portion that are integral with said arms, respectively.

8. The connector latch of claim 1, wherein said cantilever beams include a curved radius, a tapered intermediate body, a base portion, and a top portion.

9. The connector latch of claim 8, wherein said top portion has a slanted face and a sloped portion.

10. The connector latch of claim 9, wherein the width of said intermediate body decreases from said base portion to a top end on a side facing said sloped portion of said top portion.

11. The connector latch of claim 8, wherein said top portion of each cantilever beam faces away from each other.

12. The connector latch of claim 8, wherein said spring member extends between said arms and includes an upper portion that supports an upper cantilever beam, a lower portion that supports a lower cantilever beam, and a spring portion disposed between said upper and lower portions that biases against forces generated by said upper and lower cantilever beams.

13. The combination of an interconnection system and a connector latch comprising:
an interconnection system having a pair of end pieces arranged to be disposed at adjacent ends of a plurality of spacers; and
a connector latch affixed to at least one of said end pieces and comprising:
a generally U-shaped member having laterally extending arms, a body portion, and a spring member integral with said arms; and
cantilever beams projecting outwardly from said spring member, said cantilever beams being deflected proportional to an applied force or load,
wherein said spring member biases against the force generated by said cantilever beams, and said arms and body portion bias against compression of said spring member.

14. The combination of an interconnection system and a connector latch comprising:
an interconnection system having a plurality of spacers; and
a connector latch arranged to be disposed at adjacent ends of said plurality of spacers and comprising:
a generally U-shaped member having laterally extending arms, a body portion, and a spring member integral with said arms; and
cantilever beams projecting outwardly from said spring member, said cantilever beams being deflected proportional to an applied force or load,
wherein said spring member biases against the force generated by said cantilever beams, and said arms and body portion bias against compression of said spring member.

15. A latching system comprising:
an end cap comprising a first generally U-shaped member having a body portion, said body portion including a first arm member, a second arm member, and a connector member having at least one of a first connector surface and a second connector surface; and
a connector latch affixed to said at least one of said first and second connector surfaces, said connector latch comprising a second generally U-shaped member having outer spring loops including first end and upper surfaces, inner spring loops including second end and upper surfaces, and a spring member formed at said second upper surfaces of said inner spring loops,
wherein said latching system biases against compression produced from a compression mount type connector system.

16. The latching system of claim 15, wherein at least one of said first and second arm members includes a screw on its outer surface for mounting to a circuit board.

17. The latching system of claim 15, wherein at least one of said first and second arm members includes a peg on its outer surface to mold in an end cap of an electrical connector.

18. The latching system of claim 15, wherein said upper surface of said outer spring loops has a latch mounting member for mounting to an aperture of said connector member.

19. The latching system of claim 15, wherein said spring member comprises a first spring portion, a second spring portion, and a center spring portion.

20. The latching system of claim 19, wherein said connector member includes a spring peg and a spring protrusion, said spring peg and said spring protrusion securing said center spring portion of said spring member.
